(19) United States
(12) Patent Application Publication
(10) Pub. No.: US 2010/0115467 A1
(43) Pub. Date: May 6, 2010

(54) METHOD AND DEVICE FOR DETERMINING A CHARACTERISTIC QUANTITY OF AN IT SYSTEM

(75) Inventor: Markus Duus, Darmstadt (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SERVICE TRACE E.K., Darmstadt (DE)

(21) Appl. No.: 12/612,984

(22) Filed: Nov. 5, 2009

(30) Foreign Application Priority Data
Nov. 6, 2008 (EP) 08019407.9

(51) Int. Cl. G06F 3/048

(52) U.S. Cl. 715/835

(57) ABSTRACT

A method is provided for determining a characteristic quantity, in particular, the quality and/or performance, of IT systems at the application level, in particular, during operation, wherein at least one application (21, 21′) is started on at least one computer (5) of the system and wherein a time (Δt) between the starting of the application (21, 21′) and reaching a certain application state, like its actual availability to a user, is calculated and evaluated for determining the characteristic quantity. In order to achieve platform-independent usability of the method, it is further provided that at least the starting of the application (21, 21′) is performed automatically by a software automaton (11) that identifies the application (21, 21′) graphically with reference to a first icon (22) allocated to the application and that starts through the selection of a link allocated to the first icon (22), in particular, for each mouse input, wherein the identification is performed by contour-dependent pattern recognition.

### CROSS-REFERENCE TO RELATED APPLICATIONS

This application claims the benefit of European Application No. 08 019 407.9, filed Nov. 6, 2008, which is incorporated by reference herein as if fully set forth,

### BACKGROUND

The present invention relates to a method for determining a characteristic quantity, in particular, the quality and/or performance, of IT systems at the application level, in particular, during operation, wherein at least one application is started on at least one computer of the system and wherein a time between the starting of the application and reaching a certain application state, like its actual availability to a user, is calculated and evaluated for determining the characteristic quantity.

Furthermore, the invention relates to a computer program product in the form of program instructions that are stored or that can be stored on a data carrier. When these program instructions are executed on a suitable computer architecture, the method according to the invention is performed.

Finally, the invention also relates to a software-based device for determining a characteristic quantity, in particular, the quality and/or performance, of IT systems at the application level, in particular, during operation, wherein the device is implemented, in particular, under the use of the computer program product according to the invention, wherein the device is constructed to start at least one application on at least one computer of the system and to calculate a time between the starting of the application and reaching a certain application state, like its actual availability to a user, and to evaluate this time for determining the characteristic quantity, or to make this time available for a corresponding evaluation.

For monitoring the service quality in computer systems (IT systems), it is known to start applications in a defined way in the form of computer programs that form the basis of the corresponding services and then to calculate the time that elapses until the corresponding application has reached a certain state, for example, through the activation of inputs, commands, or the like.

Here, in order to determine the service quality that can actually be perceived by a user, the relevant applications are regularly started by a simulated mouse input on/in a display unit of a relevant computer, that is, on the screen or directly in the corresponding graphics card. For this purpose, it is necessary to identify the relevant applications graphically, which happens with reference to so-called icons that are regularly allocated to the applications.

According to the state of the art, for this purpose, a kind of image recognition is used that recognizes the relevant icons by searching for an arrangement of pixels with specified color values, in particular, RGB values. Here, it has proven disadvantageous that, on one hand, the mentioned pixel values can change with time, for example, due to a change in the driver or due to aging of the graphics card being used, and that, on the other hand, there is a dependency of the quality of the image recognition on the resolution of the graphics card being used, as well as on the underlying computer platform (Linux, Macintosh, Windows, . . . ), so that the image recognition and thus the entire monitoring method presents itself as relatively slow, unreliable, and susceptible to errors.

### SUMMARY

The invention is based on the objective of refining a method of the type noted above, as well as a computer program product that can be used for its implementation or a corresponding software-based device, to the extent that quick, reliable, color-independent, and resolution-independent monitoring is possible, in principle, for all applications found on the market on any computer platform.

This objective is met by a method according to the invention, by a computer program product stored in a memory of a computer according to the invention, and also by a software-based device according to the invention.

Advantageous refinements of the invention are described below and in the claims, whose wording is herewith incorporated through explicit reference into the description, in order to avoid unnecessary repetition of text.

According to the invention, a method for determining a characteristic quantity, in particular, the quality and/or performance, of IT systems at the application level, in particular, during operation, wherein at least one application is started on at least one computer of the system and wherein a time between the starting of the application and reaching a certain application state, like its actual availability for a user, is calculated and evaluated for determining the characteristic quantity, is characterized in that at least the starting of the application can be performed automatically by a software automaton that identifies the application graphically with reference to a first icon allocated to the application and that starts through the selection of a link allocated to the first icon, in particular, for each mouse input, wherein the identification is performed by contour-dependent pattern recognition.

A computer program product according to the invention comprises program instructions that are stored or that can be stored on a data carrier, such as a computer memory, wherein, when these instructions are executed on a suitable computer architecture, the method according to the invention is performed, wherein the program instructions define, in particular, the software automaton in terms of the program.

A software-based device according to the invention for determining a characteristic quantity, in particular, the quality and/or performance, of IT systems at the application level, in particular, during operation, wherein the device is implemented, in particular, under the use of the computer program product according to the invention, wherein the device is constructed to start at least one application on at least one computer of the system and to calculate a time between starting the application and reaching a certain application state, like its actual availability to a user, and to evaluate this time for determining the characteristic quantity or to make this time available for a corresponding evaluation, is characterized by a software automaton for the automatic starting of the application that is constructed for identifying the application graphically with reference to an icon allocated to the application and for starting through the selection of a link allocated to the icon, in particular, for each mouse input, wherein, for the identification, contour-dependent pattern recognition is implemented by the software automaton.

Consequently, a basic concept of the present invention is to perform the starting of at least one application whose service quality is to be monitored by a so-called software automaton, i.e., a tool acting essentially autonomously with respect to its program under the use of contour-dependent pattern recognition, in order to avoid, in this way, the disadvantages of the state of the art described farther above.

The mentioned contour-dependent pattern recognition is also known as “pattern matching” and is based, in principle, on the fact that certain pixel values (RGB values) are not looked for, but instead that an icon to be identified is initially converted into a contour or edge image representation that is then used to perform the pattern recognition. In this way, the pattern recognition is essentially independent of the type and age of the graphics card being used, the drivers being used, and the existing computer platform and allows a quick and reliable processing sequence.

A first refinement of the method according to the invention provides that the certain application state, e.g., the opening of a certain application window or the opening/storing of a file is likewise recognized graphically with reference to a second icon allocated to it. In the course of another refinement of the method according to the invention, the mentioned second icon can essentially correspond to the first icon. The term “essentially” means in this context that the basic contours that can be extracted from the second icon correspond, to the greatest part, to those of the first icon, while, for example, the size of the icon, whose color configuration, etc., could be changed. This does not, however, lead to problems in the present pattern recognition, because also the identification of the second icon is performed by the noted contour-dependent pattern recognition.

Another refinement of the method according to the invention provides that the software automaton interacts with a first software module, wherein the latter is constructed to stop the display, in particular, of visual elements in the form of so-called pop-ups or, in general, other disruptive program tracks, if these originate from or are initiated by computer programs different from the started and monitored application.

In this way it is prevented that through the display of such pop-ups or, in general, the execution of additional programs, the calculation of the characteristic quantity is corrupted, because, for example, the display of pop-ups regularly leads to a lengthening of the time calculated in the scope of the method according to the invention as a basis of the calculation of the characteristic quantity.

In this context, a preferred refinement of the method according to the invention provides that also the pop-ups are identified by an image-recognition method and blocked accordingly. Also, in the case of the image recognition method named above, it can advantageously involve contour-dependent pattern recognition.

In order to accelerate the graphical identification of at least the application to be started and consequently also the certain application state accordingly, another refinement of the method according to the invention provides that the pattern recognition is performed with reference to a previously known position of the icon in a specified area of a display unit of the computer, like a screen or a graphics card, wherein this area is preferably limited with respect to the total display area of the display unit.

For example, a user can set, by a mouse input, a certain screen area in which the relevant icon is located, so that the pattern recognition is initially performed restricted to this specified area and executes more quickly accordingly.

However, in practice it is possible that an icon to be looked for changes its position on or in the display unit of the computer, for example, because it was moved by a user. In this case, in the pattern recognition, the search restricted to a specified area leads to a non-detection of the icon at the previously known position. In this context, a corresponding refinement of the method according to the invention provides that the search or the pattern recognition is then performed heuristically across the remaining area of the display unit of the computer, wherein, in particular, search methods known from the field of databases could be used, in which the remaining area of the display unit is, in turn, divided into sub-areas and then looked through area by area, as is known to someone skilled in the art.

If such a heuristic icon search is completed successfully, in refinement of the method according to the invention, the determined new position of the icon is stored for subsequent pattern recognition of this same icon.

Another refinement of the method according to the invention again provides that the software automaton starts, in a so-called workflow, a number of applications in a specified sequence and here optionally activates specified inputs and/or instructions for reaching the certain application state in the started applications, in order, for example, to cause the opening or storing of a file, to fill out a certain form, or the like. These sequences can here be performed, in particular, regularly or routinely, for example, hourly, daily, or weekly. Here, the corresponding characteristic quantity of the IT system is calculated and logged.

Another refinement of the method according to the invention provides that the software automaton acts according to script instructions, wherein the corresponding script that contains the script instructions is generated with the use of a second software module that operates like a graphical script editor. In this way it is also possible for users without programming experience to create scripts for controlling the software automaton, in particular, through a simple drag-and-drop method on the screen of the computer. Such scripts set, in particular, what application is started when, what inputs into the applications are to be produced, and, for time measurements, what timers are to be initialized, activated, and stopped when applications are started or certain application states are reached.

The mentioned graphical script editor also allows the simple setting of icons to be looked for or to be identified, in that—as already mentioned—a display area is defined simply for each mouse input (point and click) in which the relevant icon is currently located.

The second software module translates all of the inputs performed by a user on the screen or on input devices of the computer (mouse, keyboard, . . . ) into script instructions that are then used for controlling the software automaton.

Another different refinement of the method according to the invention provides that the software automaton interacts with a third software module that is constructed to perform an especially dynamic adaptation of influential characteristic quantities of the pattern recognition. Such an adaptation is used to allow a certain intentional fuzziness in the pattern recognition and these contribute, in particular, to the fact that, in the scope of the present invention, the looked-for icons are reliably recognized independent of resolution or color depth of the provided display unit.

The mentioned dynamic adaptation of the influential characteristic quantity of the pattern recognition is especially useful when, during operation, certain properties of the display unit change, for example, through adjustment of the resolution and/or color depth or the like.

With respect to the software-based device according to the invention, a first refinement of the invention provides that the device is installed in a decentralized arrangement on at least one computer to be monitored, wherein such a system configuration is suitable, in particular, for larger locations.

Accordingly, an alternative refinement of the device according to the invention provides that this is installed in a centralized arrangement on at least one higher-level computer, for example, within a computer center that is connected in terms of communications to at least one computer to be monitored. Such a system configuration is suitable, in particular, for smaller locations.

As someone skilled in the art recognizes, however, a mixed form made from the two constructions noted above of the device according to the invention is possible and can be realized.

The present invention allows improved quality monitoring of IT systems at the application level due to its improved performance relative to previously known monitoring systems, in particular, advance testing of IT system environments on an end-to-end basis before the start of production.

Through the improved recognition method, it is possible to automatically create service level agreement (SLA) reports, in German: “Dienstgütevereinbarung (DGV)”, for essentially all applications and services found on the market. In addition, the improved pattern recognition allows the quick finding of bottleneck areas in the system.

A basic feature of the present invention is the innovative software automaton technology that is being used and that recognizes and acts like a human user.

The firewall-like function of the first software module that protects the measurement sequence against external influences, in particular, against pop-ups or the like, ensures, for a small administrative expense, “cleaner” measurement values, so that the measurements run stably and continuously without external influences.

In the scope of another refinement of the present invention, another (fourth) software module could be provided that automatically takes care of application problems occurring during the measurement and that automatically restarts the measurements, if necessary. In this way, the so-called downtimes of applications do not have to be taken into account in the measurements. In other words: the software device fixes itself. This approach also allows less administrative expense and creates increased stability in the measurements.

Here it could be provided that the functionality of the additional software module described above is made available by the graphical script or workflow editor made available by the second software module. In this way, measurement sequences could be created easily and with very high quality, so that short time-to-market cycles are produced.

The primary fields of use of the present invention are service-level monitoring, service-level reporting, the provision of a service-level portal for presenting the certain characteristic quantities, the monitoring of IT services, the automation of IT sequences, the execution of performance analyses, product/software development, the execution of load tests, capacity planning, and accounting for IT services.

### BRIEF DESCRIPTION OF THE SEVERAL VIEWS OF THE DRAWINGS

Additional properties and advantages of the present invention are produced from the following description of embodiments with reference to the drawing.

FIG. 1 shows schematically, with reference to a flow chart, the basic relationships that form the basis of the present invention,

FIG. 2 shows, with reference to a combined block circuit diagram and flow chart, a preferred construction of the present invention,

FIG. 3 shows schematically a decentralized use of the present invention, and

FIG. 4 shows schematically a centralized use of the present invention.

### DETAILED DESCRIPTION OF THE PREFERRED EMBODIMENTS

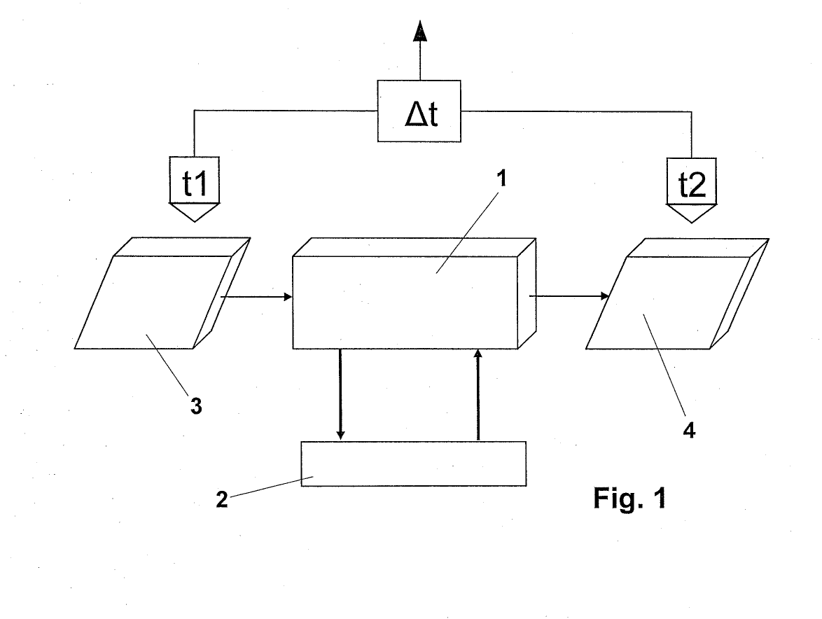

With reference to FIG. 1, initially, some basic background information should be made available for understanding the present invention.

In the case of the reference symbol 1, a process or an activity or a service is shown that is to be performed in a computer or IT system. Regularly, a software-based process or the like is involved here, wherein the present invention is not limited to a certain type of process, activity, or service. In the simplest case, such a process can involve the calling of a software application, so that this is made available to a user, for example, starting an Internet browser and opening a corresponding browser window connected with an initialization of the corresponding communications connections. However, it could also involve arbitrarily complex, composite processes that comprise the starting and ending of different applications with associated inputs and outputs, as well as the reading and storing of data or files.

Reference symbol 2 symbolizes a corresponding process goal, that is, an ultimate purpose or end result of the processes, activities, or services 1 discussed as examples farther above. For example, the process goal 2 can be that a completely initialized Internet connection is made available to a user within a certain, specified time. As already mentioned, however, the present invention is not limited to such a certain process goal 2; however, a quality requirement on the IT system is regularly linked with the process goal, like above the maximum time to be maintained, which is presently expressed, in general, in the form of a characteristic quantity to be achieved.

For triggering the process 1, regularly a (data) input 3 is required, as shown in FIG. 1. The input 3 can involve, for example, a mouse input (mouse click), a keyboard input, or the like. Reaching the process goal 2 is indicated by a corresponding (data) output 4, for example, by opening a corresponding application window on a display unit of the relevant computer, associated with the mentioned quality requirement.

Between the input 3 and the output 4, a certain time Δt elapses that indicates how long the computer or the IT system needs for reaching the process goal 2. The time Δt is given as the difference t1−t2, wherein t1 designates the time point of the input 3 and t2 designates the time point of the output 4. The time Δt can be used as a measure for the quality or performance of the computer or the IT system in the sense of the quality requirement named above, wherein the increase of Δt past a specified threshold can be evaluated as an indication of system problems, for example, caused by hardware or software conflicts, overloading, defective functions of individual system components, or the like, wherein the above list does not claim completeness.

As the corresponding arrow in FIG. 1 symbolizes, the measured time or time difference Δt can be used for calculating a corresponding characteristic quantity for the quality or performance of the system and can be provided accordingly, for example, for generating corresponding reports or the like.

In the scope of the present invention, in particular, in the determination of the time difference Δt, in an innovative way, a special type of image processing is used in the form of pattern recognition, in order to be able to perform the calculation independent of platform or operating system, as well as to be able to perform it reliably and quickly.

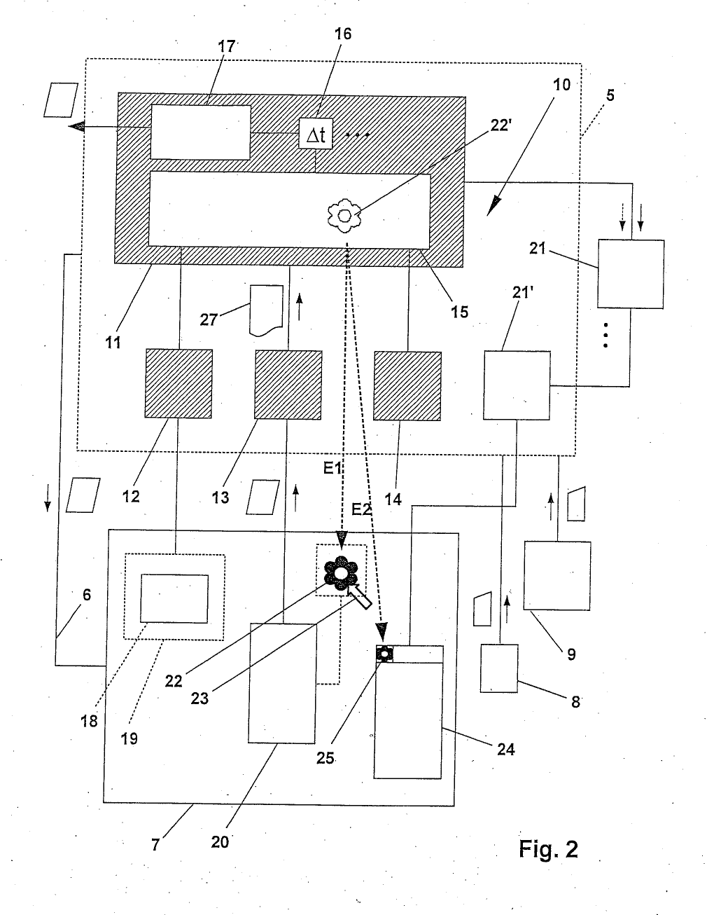

For explaining this situation, FIG. 2 shows a detailed block circuit diagram of one possible construction of the present invention.

Below, the shown hardware and software components of the system according to FIG. 2 are initially described; then a detailed description of the functional relationships and sequences follows.

Reference symbol 5 designates a computer that could be part of a larger computer network or IT system that is not shown explicitly in FIG. 2. The computer 5 makes available an active connection 6 in terms of signals to a display unit 7 in which this can involve, in particular, a screen or monitor or also directly a corresponding graphics card, which are not explicitly differentiated in FIG. 2. In the present case, two input devices for the input of data into the computer 5 are connected to the computer 5, namely a mouse 8 and a keyboard 9, without the invention being restricted to the presence of such input devices. In particular, the monitor 7 itself could also be formed as an input device, for example, in the form of a touchscreen or the like.

The computer 5 has a software-based device 10 that includes the components shown shaded in FIG. 2, namely a so-called software automaton 11, as well as first to third software modules 12, 13, 14 that are in active connection in terms of signals with the software automaton 11. As someone skilled in the art recognizes, the software device 10 basically involves program instructions that are provided for execution on a suitable processor of the computer 5, which is not shown explicitly for reasons of clarity. Obviously, for this purpose, the computer 5 typically also has a suitable storage medium, such as a disk or CD drive, RAM or hard drive for the mentioned program instructions that are similarly not shown in FIG. 2 for reasons of clarity.

The mentioned program instructions are made available to the computer 5 in the form of corresponding program data or installed on the computer 5, wherein the program data can be stored either on a suitable data carrier, like a CD-ROM or the like, or wherein the mentioned data can be made available without physical means by a communications connection, such as an Intranet or the Internet. In each case, the mentioned data forms a computer program product for creating the software device 10 on a suitable computer 5.

The already discussed software automaton 11 comprises, according to FIG. 2, at least the additional components named below, namely a pattern recognition unit 15 that will be discussed in more detail farther below, a number of software-based time measurement units (software timers) 16 in active connection with a report module 17, wherein here the components 16 and 17 guarantee just the functionalities already described above with reference to FIG. 1 for calculating Δt and making it available outside of the computer 5, which will be discussed in more detail farther below.

In the case of the first software module 12, it involves a program for monitoring the display unit 7 for undesired program windows, i.e., so-called pop-ups 18, which will be discussed in more detail farther below. In order to symbolize the monitoring function of the software module 12, in FIG. 2 a connection to a corresponding monitoring area 19 is shown in or on the display unit 7, wherein the area 19 could obviously encompass the entire display unit 7.

The second software module 13 is used for providing a graphical editor tool 20 in or on the display unit 7. Its function will also be discussed in more detail farther below.

The third software module 14 makes available, in particular, dynamic influential characteristic quantities for the pattern recognition unit 15, which will be discussed in more detail farther below.

In the case of the reference symbol 21, an arbitrary software application is shown that is executed, as a rule, not on the computer 5, but instead on a (remote) application server. The computer 5 is thus used with its display unit 7 and its input devices 8, 9 merely as a client or executes the client part 21′ of the application 21, for example, an Internet browser for Web applications. However, in principle the present invention is not limited to the situation that a part of the application software is executed on a computer that is different from the computer 5.

For starting the application 21, 21′ on the application server or the computer 5, a corresponding icon 22 is stored in or on the display unit 7, wherein this icon has a corresponding link, as is known to someone skilled in the art. Thus, by selecting or clicking on the icon 22, for example, by use of the mouse cursor 23, the corresponding application 21, 21′ can be started, for which the user of the computer 5 inputs controls according to the mouse input device 8. When the application 21, 21′ has been started and initialized accordingly and is thus available to the user, a corresponding application window 24 that likewise has an icon 25 allocated to the application 21, 21′ appears on or in the display unit 7, wherein, in the case of the icon 22 and the icon 25, advantageously they involve essentially the same icon, as shown.

With the additional reference to FIG. 1, in the present case, the time Δt=t1−t2 should be viewed as a measure for the desired process goal 2 (cf. FIG. 1), namely making the application 21, 21′ available by displaying the application window 24. In other words: the time Δt is the time that elapses between clicking on the icon 22 and the appearance of the application window 24 in or on the display unit 7 of the computer 5. The time Δt is viewed as a measure for the quality or performance of the IT system, which comprises, in the present case, at least the computer 5 and the application server on which the application 21 is executed. The time Δt can here be viewed as the characteristic quantity for the IT system; alternatively, such a characteristic quantity could be derived from the measurement of Δt.

In the case of determining the time Δt, the following is performed: the already mentioned graphical editor tool 20 that allows the user to program the sequences necessary for the planned measurement of Δt in a simple way according to the so-called drag-and-drop principle is provided by the second software module 13 on or in the display unit 7. In this way, for example, the necessary timers 16 are defined and initialized. Furthermore, the work with the graphical editor tool 20 includes the definition of an area 26 in or on the display unit 7 in which the icon 22 to be clicked on is located. The mentioned area 26 is specified with the help of the mouse cursor 23 or the input device 8. The corresponding data is transmitted from the graphical editor tool 20 to the software module 13 that generates from this data a corresponding script 27 for the software automaton 11.

In the present case, the script 27 includes, in particular, the instructions for initializing the timers 16 and then starting the application 21, 21′ by clicking on the icon 22, which is accompanied by an activation of the timer 16 (time point t1 in FIG. 1). The search or looking for the icon 22 in or on the display unit 7 is performed by the pattern recognition unit 15 of the software automaton 11.

The pattern recognition unit 15 is constructed to perform contour-dependent pattern recognition in or on the display unit 7. Contour-dependent pattern recognition means, in this context—as already mentioned above—that the icon 22 itself, that is, for example, the corresponding pixels in the RGB color space, are not looked for, but instead the pattern recognition unit 15 attempts to find the edge structure or contours of the icon 22 in or on the display unit 7. In FIG. 2, the contours of the icon 22 in the pattern recognition unit 15 are shown with the reference symbol 22′, wherein it shall be indicated that, in the case of the structure 22′, for representation-specific reasons, it can basically involve the negative of the corresponding edge structure.

This procedure has the decisive advantage that locating the icon 22 is possible somewhat independent of the computer platform being used as well as of the type and quality of the display unit 7, for example, its resolution and/or the age of the graphics card being used.

Through the use of the third software module 14, influential characteristic quantities of the pattern recognition, such as edge sharpness or the like, can be specified, in particular, dynamically, but also, for example, by the user by means of the input device 9.

Preferably, the search for the icon 22 takes place exclusively or initially in a specified area of the display unit 7 that can coincide, in particular, with the already mentioned area 26, without, however, the invention being restricted to this condition. It can also happen that the icon 22 has changed its position in or on the display unit 7 since the definition of the area 26, for example, by being moved on the part of the user. In this case, the search for the icon 22 extends accordingly across the remaining area of the display unit 7, in particular, through successive scanning of the display unit 7, until the icon 22 has been found or heuristically area by area, as is known, for example, from database search processes.

After corresponding activation of the timer 16, the software automaton 11 or its pattern recognition unit 15 tests in short, regular intervals, whether the icon 25 appears in or on the display unit 7, which indicates that, according to the diagram in FIG. 1, as an example, the process goal 2 has been reached. In this context, the pattern recognition by the pattern recognition unit 15 also takes place dependent on contours; that is, with reference to a corresponding edge image (cf. reference symbol 22′ in FIG. 2).

In this case, the search process could also be primarily limited to a specified partial area of the display unit 7, in order to find the icon 25 more quickly accordingly.

The search and locating process described above for the icons 22, 25 by the pattern recognition unit 15 are symbolized in FIG. 2 by dashed arrows E1 or E2. As soon as the icon 25 has been recognized or found, the pattern recognition unit 15 stops the timer 16 (time point t2 in FIG. 1), so that the time Δt is calculated by the count value of the timer 16 and can be output accordingly to the report module 17 for the further use within the IT system, in particular, for calculating a (derived) characteristic quantity.

During the sequences described above, the first software module 12 ensures that the time measurement by the timer 16 is not disrupted or corrupted by the appearance of pop-ups 18. The recognition of pop-ups 18 by the software module 12 is also performed through the use of the pattern recognition unit 15 of the software automaton 11, as symbolized by the corresponding connections in FIG. 2.

The software device 10 can comprise additional software modules that are not shown explicitly in FIG. 2. For example, another such software module could be provided for performing error handling, so that, for example, outage times of the application 21, that is, times at which the mentioned application is not available at all in the IT system, are not taken into consideration in the time measurement by the timer 16, if they are insignificant for determining the quality or performance of the system. In this way, the desired performance measurement can be performed automatically as planned despite errors or interference in the system.

If the icon 22—as already mentioned above—has been moved into or onto the display unit 7, the software automaton 11 notes, advantageously, the new position of the icon 22 after successful recognition by the pattern recognition unit 15 and begins a subsequent search preferably in this new area.

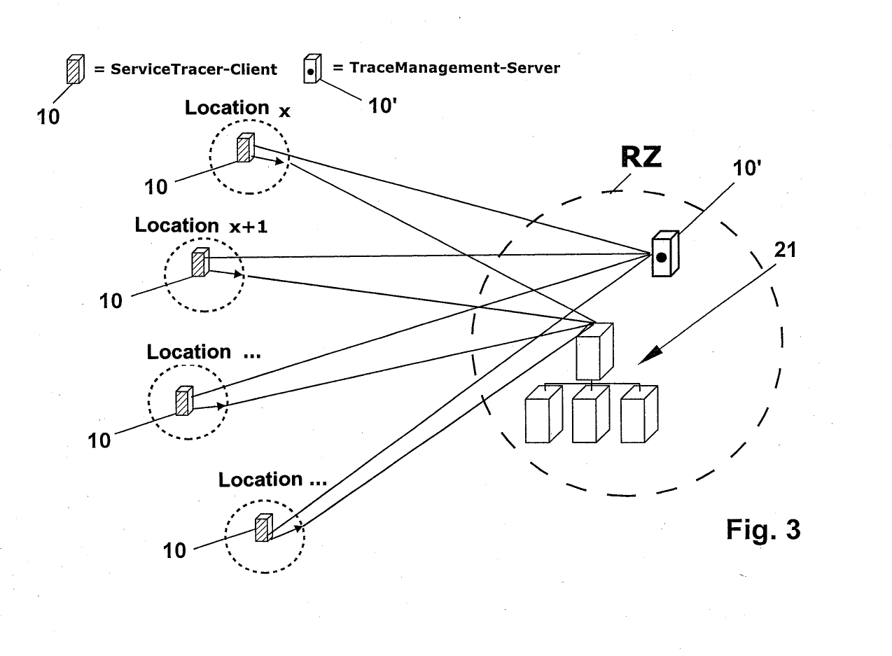

FIG. 3 shows schematically a first system-specific realization of the method according to the invention or a corresponding use of the software device 10 according to the invention described in detail farther above with reference to FIG. 2.

The construction shown in FIG. 3 is suitable, in particular, for the system configuration for larger locations. Here, the individual software devices 10, in the present case, each also designated as a ServiceTracer Client (STC), are provided locally at the individual locations, x, x+1, . . . and are each in active connection in terms of signals by a data or communications network with a corresponding server 10′ (TraceManagement Server, TMS) that is arranged in a computer center RZ spatially separated from the individual locations x, x+1, . . . . The latter furthermore comprises application systems or, in general, applications 21 (cf. FIG. 2) that are accessed from the individual locations x, x+1, . . . and accordingly from the STC's 10 provided there, in order to monitor the service quality or performance on site at the corresponding locations x, x+1, . . .

The central TMS 10′ runs explicitly in the computer center RZ and contains, in particular, a central control unit (ControlCenter) as well as a report and alarm function.

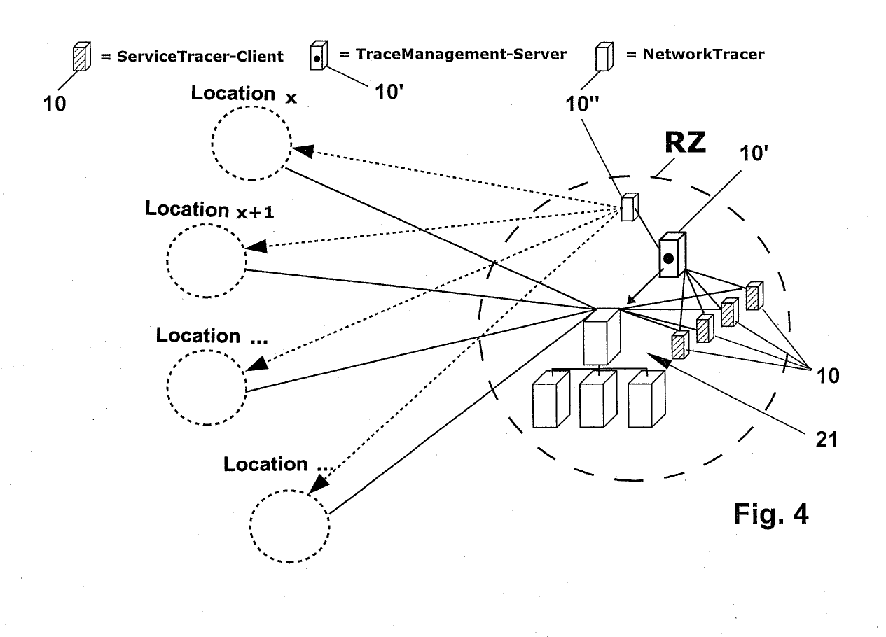

FIG. 4 shows an alternative system configuration that is suitable, in particular, for smaller locations. Different than in the subject matter of FIG. 3, in the configuration according to FIG. 4, the STC's 10 are arranged in the computer center RZ and the corresponding measurements on the application systems 21 are performed there. For this purpose, the STC's 10 are, on one hand, in active connection to the application systems 21 and, on the other hand, to the TMS 10′. Furthermore, in the computer center RZ there is also another component 10″ in the form of a so-called NetworkTracer (NWT) that constructs end-to-end connections to the individual locations x, x+1, . . . , in order to perform corresponding quality measurements of the network sections there in the scope of the present invention.

As someone skilled in the art recognizes, the constructions according to FIG. 3 and FIG. 4 can also be combined, so that a number of STC's 10 monitor the service quality on site at the locations, while, on the other hand, a number of STC's 10 also monitor the quality at the computer center RZ like a reference measurement. In all of these cases, at least a certain number of STC's 10 being used are in operation, as described in more detail farther above with reference to FIG. 1 and FIG. 2.

The STC's 10 report bottlenecks of the applications or application systems 21 in advance, so that these can be identified more quickly and can be avoided for the user, which leads to corresponding cost savings.

The NWT 10″ (cf. FIG. 4) monitors the network qualities at all locations x, x+1, . . . end-to-end, i.e., across the entire connection section between the origin and destination, so that problem search times can be shortened and bottlenecks can be identified in advance accordingly.

The TMS 10′ controls the decentralized STC's and NWT's, stores the correspondingly obtained data, issues alarms, evaluates the data according to defined Service Level Agreements (SLA) or “Dienstgütevereinbarung (DGV)” with respect to the mentioned characteristic quantities, and creates goal-group-oriented reports that can be retrieved via a Web portal (not shown explicitly).

A core piece is here, in each case, the high-speed image recognition that is independent of platform, color, and resolution and that is made possible by the software device (STC) 10, in particular, according to FIG. 2 and that allows, in the scope of the present invention, the operation of all of the applications found on the market in a novel way.

1. Method for determining a characteristic quantity relating to a quality and/or performance, of IT systems at an application level, comprising starting at least one application (21, 21′) on at least one computer (5) of the system and calculating and evaluating a time (Δt) between the starting of the at least one application (21, 21′) and reaching a certain application state for determining the characteristic quantity, at least the starting of the at least one application (21, 21′) is performed automatically by a software automaton (11) that identifies the at least one application (21, 21′) graphically with reference to a first icon (22) allocated to the at least one application and that starts through a selection of a link allocated to the first icon (22), and the identification is performed by contour-dependent pattern recognition.

2. Method according to claim 1, wherein the certain application state is recognized graphically with reference to a second icon (25) allocated to the certain application state, wherein this icon essentially corresponds, in particular, to the first icon (22), and identification of the second icon (25) is also performed by contour-dependent pattern recognition.

3. Method according to claim 1, wherein the software automaton (11) interacts with a first software module (12) that stops a display of visual elements in a form of pop-ups (18) by additional computer programs that are different from the at least one application (21, 21′) that is started.

4. Method according to claim 3, characterized in that the pop-ups (18) are recognized by an image-recognition method using contour-dependent pattern recognition.

5. Method according to claim 1, wherein the contour-dependent pattern recognition is performed with reference to a previously known position of the icon (22, 25) initially in a limited, specified area (26) of a display unit (7) of the computer (5).

6. Method according to claim 5, wherein when the icon (22, 25) is not recognized at the previously known position (26), then the pattern recognition is performed heuristically across a remaining area of the display unit (7) of the computer (5).

7. Method according to claim 6, wherein in the case of a successful pattern recognition, a new position of the icon (22, 25) is stored for subsequent pattern recognition processes of the icon.

8. Method according to claim 1, wherein the software automaton (11) starts, regularly or routinely, a number of the applications (21, 21′) in a specified sequence and activates specified inputs and/or instructions for reaching the certain application state in the applications (21, 21′) that are started, and a corresponding characteristic quantity of the IT system is determined and logged.

9. Method according to claim 8, wherein the software automaton (11) acts according to script instructions, the corresponding script (27) is generated via use of a second software module (13) as a graphical script editor (20).

10. Method according to claim 9, wherein the icons (22, 25) to be recognized and corresponding areas of the display unit (7) of the computer (5) are incorporated into the script (27).

11. Method according to claim 1, wherein the icons (22, 25) to be recognized and corresponding areas of the display unit (7) of the computer (5) are set on the screen for each mouse input.

12. Method according to claim 1, wherein the software automaton (11) interacts with a third software module (14) that performs an especially dynamic adaptation of influential characteristic quantities of the pattern recognition, in order to allow a certain, intentional fuzziness in the pattern recognition.

13. Method according to claim 1, wherein the method to determine the a characteristic quantity is carried out during operation, the reaching of the certain application state is an actual availability of the application to a user, and the selection of the link allocated to the first icon is via a mouse input.

14. Computer program product comprising program instructions stored in a computer readable media and when the instructions are executed on a suitable computer architecture (5), the program instructions define at least one of a software automaton (11), a first software module (12), a second software module (13) or a third software module (14), that are used for determining a characteristic quantity relating to a quality and/or performance of IT systems at an application level, through starting at least one application (21, 21′) on at least one computer (5) of the system and calculating and evaluating a time (Δt) between the starting of the at least one application (21, 21′) and reaching a certain application state for determining the characteristic quantity, in which at least the starting of the at least one application (21, 21′) is performed automatically by the software automaton (11) that identifies the at least one application (21, 21′) graphically with reference to a first icon (22) allocated to the at least one application and that starts through a selection of a link allocated to the first icon (22), and the identification is performed by contour-dependent pattern recognition.

15. The device (10) according to claim 14, wherein the device (10) is installed in a centralized arrangement on at least one higher-level computer that is in communications connection with the computer (5) to be monitored.

16. A software-based device (10) for determining a characteristic quantity relating to a quality and/or performance of IT systems at an application level, the device (10) the device (10) comprising a computer with a computer program that starts at least one application (21, 21′) on the computer (5) which calculates a time (Δt) between a starting of the application (21, 21′) and reaching a certain application state, and evaluates the time for determining the characteristic quantity, or to make the time available for a corresponding evaluation, the computer program defining a software automaton (11) for automatically starting the application (21, 21′) that is constructed to identify the application (21, 21′) graphically with reference to an icon (22) allocated to the application and to start through the selection of a link allocated to the icon (22), and for the identification, contour-dependent pattern recognition (15) is implemented by the software automaton (11).

17. The device (10) according to claim 16, wherein the device (10) is installed in a decentralized arrangement on the computer (5) to be monitored.
